(19) United States
(12) Patent Application Publication
(10) Pub. No.: US 2024/0388927 A1
(43) Pub. Date: Nov. 21, 2024

(54) Information Transmission Method, Terminal, and Network Side Device

(71) Applicant: VIVO MOBILE COMMUNICATION CO., LTD., Dongguan (CN)

(72) Inventors: Yu Yang, Dongguan (CN); Rongrong Sun, Dongguan (CN); Peng Sun, Dongguan (CN); Yang Song, Dongguan (CN)

(21) Appl. No.: 18/787,469

(22) Filed: Jul. 29, 2024

Related U.S. Application Data
(63) Continuation of application No. PCT/CN2023/073727, filed on Jan. 29, 2023.

(30) Foreign Application Priority Data
Jan. 29, 2022 (CN) 202210112154.4

(51) Int. Cl. H04W 16/28; H04L 5/00; H04W 8/22

(52) U.S. Cl. CPC H04W 16/28; H04L 5/0051; H04W 8/22

(57) ABSTRACT

An information transmission method includes reporting, by a terminal, a beam report to a network side device based on a beam measurement result, where the beam report is used to determine N pieces of beam information of uplink signals that the terminal is capable of simultaneously sending; and receiving, by the terminal, first indication information from the network side device. The first indication information is used to indicate the terminal to simultaneously send uplink signals by using the N pieces of beam information. N is a positive integer greater than or equal to 2.

### CROSS-REFERENCE TO RELATED APPLICATIONS

This application is a Bypass Continuation Application of International Patent Application No. PCT/CN2023/073727, filed Jan. 29, 2023, and claims priority to Chinese Patent Application No. 202210112154.4, filed Jan. 29, 2022, the disclosures of which are hereby incorporated by reference in their entireties.

### BACKGROUND OF THE INVENTION

### Field of the Invention

This application pertains to the field of mobile communication technologies, and particularly to an information transmission method, a terminal, and a network side device.

### Description of Related Art

After beam measurement, a terminal (also referred to as user equipment (UE)) reports a beam report to a network side device based on a beam measurement result. The network side device may perform, based on the beam report, beam indication on downlink and uplink channels or reference signals, to establish a beam link between the network side device and the terminal, and transmit channels or reference signals.

For a multi-panel terminal (MPUE), panel activation and panel selection need to be performed before signal measurement and transmission. In terms of radio frequency (RF), each UE panel includes a set of transmit (TX) and receive (RX) units for generating an analog beam. A quantity of antenna ports, a quantity of beams, and equivalent isotropically radiated power (EIRP) supported by different UE panels may be the same or different.

### SUMMARY OF THE INVENTION

According to a first aspect, an information transmission method is provided. The method is applied to a terminal and includes:

The terminal reports a beam report to a network side device based on a beam measurement result, where the beam report is used to determine N pieces of beam information of uplink signals that the terminal is capable of simultaneously sending.

The terminal receives first indication information from the network side device, where the first indication information is used to indicate the terminal to simultaneously send uplink signals by using the N pieces of beam information.

N is a positive integer greater than or equal to 2.

According to a second aspect, an information transmission apparatus is provided, including:
a reporting module, configured to report a beam report to a network side device based on a beam measurement result, where the beam report is used to determine N pieces of beam information of uplink signals that are capable of being simultaneously sent; and
a transmission module, configured to receive first indication information from the network side device, where the first indication information is used to indicate to simultaneously send uplink signals by using the N pieces of beam information.

N is a positive integer greater than or equal to 2.

According to a third aspect, an information transmission method is provided. The method is applied to a network side device and includes:

The network side device receives a beam report from a terminal.

The network side device determines, based on the beam report, N pieces of beam information of uplink signals that the terminal is capable of simultaneously sending.

The network side device sends first indication information to the terminal, where the first indication information is used to indicate the terminal to simultaneously send uplink signals by using the N pieces of beam information.

N is a positive integer greater than or equal to 2.

According to a fourth aspect, an information transmission apparatus is provided, including:
a receiving module, configured to receive a beam report from a terminal;
a configuration module, configured to determine, based on the beam report, N pieces of beam information of uplink signals that the terminal is capable of simultaneously sending; and
a sending module, configured to send first indication information to the terminal, where the first indication information is used to indicate the terminal to simultaneously send uplink signals by using the N pieces of beam information.

N is a positive integer greater than or equal to 2.

According to a fifth aspect, a terminal is provided. The terminal includes a processor and a memory, the memory stores a program or an instruction executable on the processor, and the program or the instruction is executed by the processor to implement the steps of the method according to the first aspect.

According to a sixth aspect, a terminal is provided, including a processor and a communication interface. The processor is configured to obtain a beam measurement result, and the communication interface is configured to: report a beam report to a network side device based on the beam measurement result; and receive first indication information from the network side device, where the first indication information is used to indicate to simultaneously send uplink signals by using the N pieces of beam information.

According to a seventh aspect, a network side device is provided. The network side device includes a processor and a memory, the memory stores a program or an instruction executable on the processor, and the program or the instruction is executed by the processor to implement the steps of the method according to the first aspect.

According to an eighth aspect, a network side device is provided, including a processor and a communication interface. The processor is configured to determine, based on a beam report, N pieces of beam information of uplink signals that a terminal is capable of simultaneously sending. The communication interface is configured to: receive the beam report of the terminal; and send first indication information to the terminal, where the first indication information is used to indicate the terminal to simultaneously send uplink signals by using the N pieces of beam information.

According to a ninth aspect, an information transmission system is provided, including a terminal and a network side device. The terminal may be configured to perform the steps of the information transmission method according to the first aspect, and the network side device may be configured to perform the steps of the information transmission method according to the third aspect.

According to a tenth aspect, a non-transitory readable storage medium is provided. The non-transitory readable storage medium stores a program or an instruction, and the program or the instruction is executed by a processor to implement the steps of the method according to the first aspect, or to implement the steps of the method according to the third aspect.

According to an eleventh aspect, a chip is provided. The chip includes a processor and a communication interface. The communication interface is coupled to the processor, and the processor is configured to run a program or an instruction to implement the method according to the first aspect, or to implement the method according to the third aspect.

According to a twelfth aspect, a computer program/program product is provided. The computer program/program product is stored in a non-transitory storage medium, and the computer program/program product is executed by at least one processor to implement the information transmission method according to the first aspect, or to implement the steps of the information transmission method according to the third aspect.

### BRIEF DESCRIPTION OF THE DRAWINGS

FIG. 1 is a diagram of a structure of a wireless communication system to which embodiments of this application may be applied;

FIG. 2 is a schematic flowchart of an information transmission method according to an embodiment of this application;

FIG. 3 is a diagram of a structure of an information transmission apparatus according to an embodiment of this application;

FIG. 4 is a schematic flowchart of another information transmission method according to an embodiment of this application;

FIG. 5 is a diagram of a structure of another information transmission apparatus according to an embodiment of this application;

FIG. 6 is a diagram of a structure of a communication device according to an embodiment of this application;

FIG. 7 is a diagram of a structure of a terminal that implements an embodiment of this application; and

FIG. 8 is a diagram of a structure of a network side device that implements an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a long term evolution (LTE)/LTE-advanced (LTE-A) system, and may further be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6^{th} generation (6G) communication system.

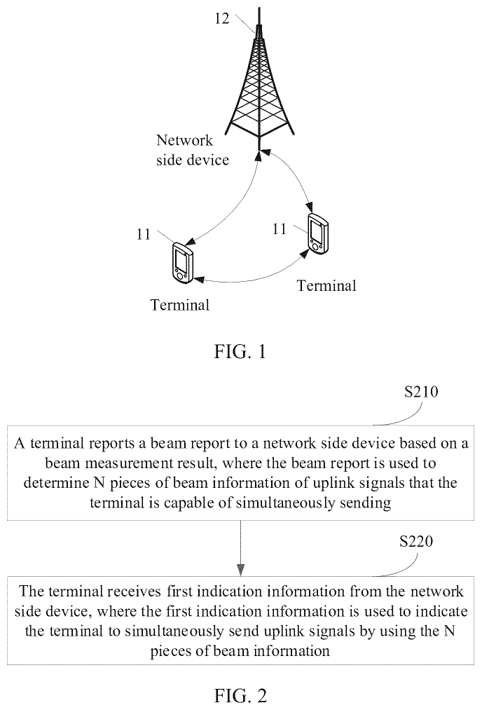

FIG. 1 shows a block diagram of a wireless communication system to which embodiments of this application may be applied. The wireless communication system includes terminals 11 and a network side device 12. The terminals 11 each may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine. The wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a wireless local area network (WLAN) access node, a wireless fidelity (WiFi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that, in the embodiments of this application, only a core network device in an NR system is used as an example for description, and a specific type of the core network device is not limited.

At present, for the MPUE, a plurality of panels of the terminal may each simultaneously form a respective uplink (UL) beam. However, the network side device is not capable of determining which UL beams may be simultaneously used, which is prone to resource waste.

The following describes in detail the information transmission method provided in the embodiments of this application through some embodiments and application scenarios thereof with reference to the accompanying drawings.

As shown in FIG. 2, an embodiment of this application provides an information transmission method. The method may be performed by a terminal. In other words, the method may be performed by software or hardware installed in the terminal. The information transmission method includes the following steps.

S210: The terminal reports a beam report to a network side device based on a beam measurement result, where the beam report is used to determine N pieces of beam information of uplink signals that the terminal is capable of simultaneously sending, where N is a positive integer greater than or equal to 2. For simplicity, the following embodiments use N=2 as an example for description.

Before step S210, the method further includes:

The network side device indicates a related parameter of the beam report to the terminal, where the related parameter includes content and a format of the beam report, and the like. For example, it may be indicated that the beam report includes a reference signal resource indicator, beam link quality information, and the like, and the beam report is a non-group-based or group-based beam report.

The network side device sends a reference signal for beam measurement, where the reference signal may be a synchronization signal block (SSB) or a channel state information reference signal (CSI-RS).

The terminal obtains the beam measurement result by measuring the reference signal, and sends the beam report to the network side device based on the beam measurement result.

The network side device determines, based on the beam report, N pieces of beam information of uplink signals that the terminal is capable of simultaneously sending.

It should be understood that the beam information may also be referred to as identification information of a beam, spatial relation information, spatial domain transmission filter information, spatial domain reception filter information, spatial filter information, transmission configuration indicator state (TCI state) information, quasi co-location (QCL) information, a QCL parameter, or the like. Downlink beam information may usually be represented by the TCI state information or the QCL information. Uplink beam information may usually be represented by the TCI state information or the spatial relation information.

S220: The terminal receives first indication information from the network side device, where the first indication information is used to indicate the terminal to simultaneously send uplink signals by using the N pieces of beam information.

Each of the N pieces of beam information corresponds to any one of the following:
panel identification information of the terminal;
capability value information of the terminal; and
capability value set information of the terminal.

In an implementation, before beam measurement is performed, the terminal may first send at least one of the foregoing information to the network side device. For example, a group of capability value information or a group of capability value set information is included in capability information reported by the UE.

It should be understood that a panel may also be referred to as an antenna group, an antenna port group, an antenna set, an antenna port set, a beam set, a beam sub-set, an antenna array, an antenna port array, an antenna sub-array, an antenna port sub-array, a logical entity, an entity or an antenna entity, a panel entity, a timing error group (TEG), or the like.

It should be understood that an identifier of the panel may be an identifier of an antenna panel, a reference signal resource identifier, a reference signal resource set identifier, a TCI state identifier, a QCL information identifier, a spatial relationship identifier, or the like.

It should be understood that the capability value or the capability value set may include at least one of parameters such as a quantity of ports, a quantity of layers, a rank, or a coherence type of a sounding reference signal (SRS) that is supported by the terminal.

According to the technical solution in the foregoing embodiment, in this embodiment of this application, the terminal reports the beam report to the network side device based on the beam measurement result, and the network side device determines, based on the beam report, the N pieces of beam information of uplink signals that the terminal is capable of simultaneously sending, and indicates the terminal to simultaneously send uplink signals by using the N pieces of beam information. Therefore, beam information of uplink signals that are capable of being simultaneously sent in a multi-panel terminal is quickly determined, and resource utilization efficiency is improved.

Based on the foregoing embodiment, the beam report may be in a variety of formats, such as using a non-group-based beam report and/or a group-based beam report.

In an implementation, the beam report may include at least one of the following:
a reference signal resource indicator;
a first index corresponding to the reference signal resource indicator; or
beam link quality information corresponding to the reference signal resource indicator.

The reference signal resource indicator includes a synchronization signal block resource indicator (SSBRI), a channel state information reference signal resource indicator (CRI), and the like, which are represented as SSBRI/CRI in the following embodiments. A reference signal of the reference signal resource indicator is a reference signal (RS) resource for beam measurement, SSBRI indicates an SSB resource for beam measurement, and CRI indicates a CSI-RS resource for beam measurement.

The first index is used to indicate first information of the terminal, where the first information is any one of the following:
panel identification information of the terminal;
capability value information of the terminal; and
capability value set information of the terminal.

The beam link quality information may include a layer 1 reference signal received power (L1-RSRP), a layer 1 signal-to-noise and interference ratio (L1-SINR), and is represented as L1-RSRP/L1-SINR in the following embodiments.

For example, a beam report 1 is shown as follows:
{SSBRI/CRI #1, SSBRI/CRI #2, SSBRI/CRI #3, SSBRI/CRI #4,
L1-RSRP/L1-SINR #1, L1-RSRP/L1-SINR #2,
L1-RSRP/L1-SINR #3, L1-RSRP/L1-SINR #4,
index #1, index #2, index #3, index #4}.

It can be learned that the beam report 1 includes four reference signal resource indicators: SSBRI/CRI #1, SSBRI/CRI #2, SSBRI/CRI #3, and SSBRI/CRI #4.

Pieces of beam link quality information each respectively corresponding to each reference signal resource indicator are: L1-RSRP/L1-SINR #1, L1-RSRP/L1-SINR #2, L1-RSRP/L1-SINR #3, and L1-RSRP/L1-SINR #4.

First indexes each corresponding to each reference signal resource indicator are: index #1, index #2, index #3, and index #4.

The first indexes each corresponding to each reference signal resource indicator may be the same or different.

In an implementation, the N pieces of beam information of uplink signals that the terminal is capable of simultaneously sending may be determined based on reference signal resource indicators corresponding to N different first indexes. For example, in the beam report 1, if values of index #1 and index #2 are different, it is determined that the terminal may simultaneously send uplink signals based on the two pieces of beam information corresponding to SSBRI/CRI #1 and SSBRI/CRI #2. For example, an RS resource indicated by SSBRI/CRI #1 and SSBRI/CRI #2 is used as a source reference signal of an uplink channel or an uplink reference signal (RS), so that the uplink channel or the uplink RS may be scheduled by the network side device and simultaneously sent by the terminal by using multiple beams. In this case, the multiple beams used to simultaneously send the uplink signal correspond to different first indexes, and may be understood as corresponding to different terminal panels. The uplink reference signal may be an SRS or the like.

A quantity of pieces of beam link quality information corresponding to the reference signal resource indicator in the beam report may be one or more.

For example, a beam report 2 is shown as follows:
{SSBRI/CRI #1,
SSBRI/CRI #2,
SSBRI/CRI #3,
SSBRI/CRI #4,
{L1-RSRP/L1-SINR #1, L1-RSRP/L1-SINR #2} of SSBRI/CRI #1,
{L1-RSRP/L1-SINR #3, L1-RSRP/L1-SINR #4} of SSBRI/CRI #2,
{L1-RSRP/L1-SINR #5} of SSBRI/CRI #3,
{L1-RSRP/L1-SINR #6} of SSBRI/CRI #4}.

It can be learned that, in the beam report 2, SSBRI/CRI #1 and SSBRI/CRI #2 are respectively corresponding to two pieces of beam link quality information, and reference signal resource indicators SSBRI/CRI #3 and SSBRI/CRI #4 are respectively corresponding to one piece of beam link quality information.

In an implementation, when the reference signal resource indicator corresponds to a plurality of pieces of beam link quality information, the N pieces of beam information of uplink signals that the terminal is capable of simultaneously sending may be determined based on the reference signal resource indicator corresponding to the plurality of pieces of beam link quality information. For example, in the beam report 2, because both SSBRI/CRI #1 and SSBRI/CRI #2 correspond to two L1-RSRP/L1-SINRs, it may be understood that the terminal performs beam measurement on each SSB or CSI-RS by using two panels and reports two pieces of beam link quality information. The corresponding two pieces of beam information for uplink sending may be determined based on two pieces of beam information for downlink reception used by the terminal when measuring the two pieces of beam link quality information corresponding to SSBRI/CRI #1. Alternatively, the corresponding two pieces of beam information for uplink sending may be determined based on two pieces of beam information for downlink reception used by the terminal when measuring the two pieces of beam link quality information corresponding to SSBRI/CRI #2. In this way, two pieces of beam information of uplink signals that the terminal is capable of simultaneously sending are determined. In other words, the RS resource indicated by SSBRI/CRI #1 or SSBRI/CRI #2 is used as the source reference signal of the uplink channel or the uplink RS. Accordingly, when the reference signal resource indicator corresponds to only one piece of beam link quality information, a plurality of pieces of beam information of uplink signals that are capable of being simultaneously sent cannot be determined, for example, for SSBRI/CRI #3 and SSBRI/CRI #4.

In another implementation, the beam report may further include:
second indication information corresponding to the reference signal resource indicator, where the second indication information is used to indicate whether the reference signal resource indicator corresponding to a plurality of pieces of beam link quality information may be used to determine the N pieces of beam information of uplink signals that the terminal is capable of simultaneously sending. In this case, for the reference signal resource indicator corresponding to the plurality of pieces of beam link quality information, it is further needed to determine, based on the second indication information, whether the N pieces of beam information of uplink signals that the terminal is capable of simultaneously sending may be determined based on the reference signal resource indicator. For example, two pieces of second indication information Indication #1 and Indication #2 corresponding to SSBRI/CRI #1 and SSBRI/CRI #2 are added to the beam report 2. If Indication #1 indicates N pieces of beam information that can be used to determine that the terminal is capable of simultaneously sending uplink signals, and Indication #2 indicates N pieces of beam information that cannot be used to determine that the terminal is capable of simultaneously sending uplink signals, then the corresponding two pieces of beam information of uplink signals that are capable of being simultaneously sent and that are for uplink sending may be determined based on two pieces of beam information for downlink reception used by the terminal when measuring the two pieces of beam link quality information corresponding to SSBRI/CRI #1. For example, the two pieces of beam information are from two terminal panels. Two pieces of beam information corresponding to the two pieces of beam link quality information corresponding to SSBRI/CRI #2 cannot be used to determine two pieces of beam information of uplink signals that are simultaneously sent. For example, the two pieces of beam information are from one terminal panel.

In another implementation, the N pieces of beam information of uplink signals that the terminal is capable of simultaneously sending may be further determined based on an arrangement order or a position of the reference signal resource indicator in the beam report, which may be agreed upon through a protocol or configured by a network side. For example, for the beam report 1, beam information corresponding to the first two arranged reference signal resource indicators may be determined as beam information of uplink signals that are capable of being simultaneously sent.

In an implementation, when determining the N pieces of beam information of uplink signals that the terminal is capable of simultaneously sending, a reference signal indicated by the reference signal resource indicator, that is, an SSB Resource or CSI-RS Resource, may be configured as a source reference signal of the beam information, that is, configured as a source reference signal in TCI state information, QCL information, or spatial relation information.

A format of the beam report in this embodiment of this application may be considered as a non-group-based beam report. In an implementation, before step S210, the method further includes:

The terminal receives third indication information from the network side device, where the third indication information is used to indicate that the beam report to be reported by the terminal includes a non-group-based beam report.

It can be learned from the technical solution of the foregoing embodiment that, in this embodiment of this application, the beam report includes at least one of the following: the reference signal resource indicator; the first index corresponding to the reference signal resource indicator, where the first index is used to indicate the first information of the terminal; the beam link quality information corresponding to the reference signal resource indicator; or the second indication information corresponding to the reference signal resource indicator. Therefore, the network side device is capable of quickly determining, based on the beam report, the N pieces of beam information of uplink signals that the terminal is capable of simultaneously sending, and indicating the N pieces of beam information of uplink signals that the terminal is capable of simultaneously sending, thereby improving resource utilization efficiency.

Based on the foregoing embodiment, the beam report may include at least one of the following:
a group (resource group) including at least one reference signal resource indicator; or
beam link quality information respectively corresponding to a reference signal resource indicator included in the group.

For example, a beam report 3 is shown as follows:
{{SSBRI/CRI #1, SSBRI/CRI #2} of 1^{st} resource group,
{SSBRI/CRI #3, SSBRI/CRI #4} of 2^{nd} resource group,
{SSBRI/CRI #5, SSBRI/CRI #6} of 3^{rd} resource group,
{SSBRI/CRI #7, SSBRI/CRI #8} of 4^{th} resource group,
{L1-RSRP/L1-SINR #1, L1-RSRP/L1-SINR #2} of 1^{st} resource group,
{L1-RSRP/L1-SINR #3, L1-RSRP/L1-SINR #4} of 2^{nd} resource group,
{L1-RSRP/L1-SINR #5, L1-RSRP/L1-SINR #6} of 3^{rd} resource group,
{L1-RSRP/L1-SINR #7, L1-RSRP/L1-SINR #8} of 4^{th} resource group}.

It can be learned that the beam report 3 includes four groups: a 1^{st} resource group, a 2^{nd} resource group, a 3^{rd} resource group, and a 4^{th} resource group, and each group includes two reference signal resource indicators.

In an implementation, the N pieces of beam information of uplink signals that the terminal is capable of simultaneously sending may be determined based on the reference signal resource indicator included in the group. For example, by default, N pieces of beam information corresponding to a plurality of reference signal resource indicators included in each group are the N pieces of beam information of uplink signals that are capable of being simultaneously sent. For example, in the beam report 3, uplink signals are capable of being simultaneously sent based on two pieces of beam information corresponding to two reference signal resource indicators included in each group.

In another implementation, the beam report further includes a first index respectively corresponding to a reference signal resource indicator included in the group, where the first index is used to indicate first information of the terminal.

For example, a beam report 4 is shown as follows:
{{SSBRI/CRI #1, SSBRI/CRI #2} of 1^{st} resource group,
{SSBRI/CRI #3, SSBRI/CRI #4} of 2^{nd} resource group,
{SSBRI/CRI #5, SSBRI/CRI #6} of 3^{rd} resource group,
{SSBRI/CRI #7, SSBRI/CRI #8} of 4^{th} resource group,
{L1-RSRP/L1-SINR #1, L1-RSRP/L1-SINR #2} of 1^{st} resource group,
{L1-RSRP/L1-SINR #3, L1-RSRP/L1-SINR #4} of 2^{nd} resource group,
{L1-RSRP/L1-SINR #5, L1-RSRP/L1-SINR #6} of 3^{rd} resource group,
{L1-RSRP/L1-SINR #7, L1-RSRP/L1-SINR #8} of 4^{th} resource group,
{index #1, index #2} of 1^{st} resource group,
{index #3, index #4} of 2^{nd} resource group,
{index #5, index #6} of 3^{rd} resource group,
{index #7, index #8} of 4^{th} resource group}.

It can be learned that a first index corresponding to each reference signal resource indicator in the group is added to the beam report 4 compared with the beam report 3.

In an implementation, the N pieces of beam information of uplink signals that the terminal is capable of simultaneously sending may be determined based on reference signal resource indicators that are included in the group and that correspond to different first indexes. For example, if indexes respectively corresponding to SSBRI/CRI #1 and SSBRI/CRI #2 in the 1^{st} resource group is different, beam information corresponding to SSBRI/CRI #1 and SSBRI/CRI #2 may be determined as beam information of uplink signals that are capable of being simultaneously sent.

If first indexes corresponding to the reference signal resource indicators included in the group are the same, it may be determined that downlink signals are capable of being simultaneously received based on beam information of the reference signal resource indicators included in the group, that is, corresponding downlink channels or downlink reference signals are capable of being simultaneously received. In this case, beam information corresponding to a plurality of SSBRI/CRIs in one group is from one panel of the terminal. Therefore, only downlink multiple beams are capable of being simultaneously received, but uplink multiple beams are not capable of being simultaneously sent.

If first indexes corresponding to the reference signal resource indicators included in the group are different, it may be determined that uplink signals are capable of being simultaneously sent based on N pieces of beam information corresponding to the reference signal resource indicators included in the group, and downlink signals are capable of being simultaneously received.

In each group, a quantity of pieces of beam link quality information corresponding to the reference signal resource indicator may be one or more.

For example, a beam report 5 is shown as follows:
{{SSBRI/CRI #1, SSBRI/CRI #2} of 1^{st} resource group,
{SSBRI/CRI #3, SSBRI/CRI #4} of 2^{nd} resource group,
{SSBRI/CRI #5, SSBRI/CRI #6} of 3^{rd} resource group,
{SSBRI/CRI #7, SSBRI/CRI #8} of 4^{th} resource group,
{L1-RSRP/L1-SINR #1, L1-RSRP/L1-SINR #2} of SSBRI/CRI #1 of 1^{st} resource group,
{L1-RSRP/L1-SINR #3, L1-RSRP/L1-SINR #4} of SSBRI/CRI #2 of 1^{st} resource group,
{L1-RSRP/L1-SINR #5, L1-RSRP/L1-SINR #6} of SSBRI/CRI #3 of 2^{nd} resource group,
{L1-RSRP/L1-SINR #7} of SSBRI/CRI #4 of 2^{nd} resource group,
{L1-RSRP/L1-SINR #8} of SSBRI/CRI #5 of 3^{rd} resource group,
{L1-RSRP/L1-SINR #9} of SSBRI/CRI #6 of 3^{rd} resource group,
{L1-RSRP/L1-SINR #10} of SSBRI/CRI #7 of 4^{th} resource group,
{L1-RSRP/L1-SINR #11} of SSBRI/CRI #8 of 4^{th} resource group}.

In an implementation, when at least one reference signal resource indicator in the reference signal resource indicators included in the group corresponds to a plurality of pieces of beam link quality information, the N pieces of beam information of uplink signals that the terminal is capable of simultaneously sending may be determined based on the reference signal resource indicator that is in the group and that corresponds to the plurality of pieces of beam link quality information.

If the reference signal resource indicators included in the group each correspond to a plurality of pieces of beam link quality information, uplink signals are capable of being simultaneously sent based on N pieces of beam information corresponding to the reference signal resource indicators included in the group. For example, if SSBRI/CRI #1 and SSBRI/CRI #2 that are included in the 1^{st} resource group in the beam report 5 each correspond to two pieces of beam link quality information, uplink signals are capable of being simultaneously sent based on beam information corresponding to SSBRI/CRI #1 and beam information corresponding to SSBRI/CRI #2. Alternatively, two pieces of beam information for uplink sending may be determined based on two pieces of beam information that correspond to SSBRI/CRI #1 and that are for downlink reception, to simultaneously send uplink signals. Alternatively, two pieces of beam information for uplink sending may be determined based on two pieces of beam information that correspond to SSBRI/CRI #2 and that are for downlink reception, to simultaneously send uplink signals.

If the reference signal resource indicators included in the group each correspond to only one piece of beam link quality information, uplink signals are not capable of being simultaneously sent based on beam information corresponding to the reference signal resource indicators included in the group, for example, the 3^{rd} resource group and the 4^{th} resource group in the beam report 5.

If the reference signal resource indicators included in the group includes a reference signal resource indicator corresponding to a plurality of pieces of beam link quality information and a reference signal resource indicator corresponding to only one piece of beam link quality information, uplink signals are capable of being simultaneously sent based on N pieces of beam information corresponding to the reference signal resource indicator corresponding to the plurality of pieces of beam link quality information, for example, SSBRI/CRI #3 of the 2^{nd} resource group in the beam report 5. However, uplink signals are not capable of being simultaneously sent based on beam information corresponding to the reference signal resource indicator corresponding to only one piece of beam link quality information, for example, SSBRI/CRI #4 of the 2^{nd} resource group in the beam report 5.

In another implementation, the beam report may further include fourth indication information corresponding to the group, where the fourth indication information is used to indicate at least one of the following:
determining whether N pieces of beam information corresponding to a reference signal resource indicator included in the group are the N pieces of beam information of uplink signals that the terminal is capable of simultaneously sending;
determining whether N pieces of beam information corresponding to the reference signal resource indicator included in the group are N pieces of beam information of downlink signals that the terminal is capable of simultaneously receiving;
a quantity of spatial filters used by the terminal when measuring a first reference signal included in the group; or
a quantity of panels used by the terminal when measuring the first reference signal included in the group.

For example, a beam report 6 is shown as follows:
{{SSBRI/CRI #1, SSBRI/CRI #2} of 1^{st} resource group,
{SSBRI/CRI #3, SSBRI/CRI #4} of 2^{nd} resource group,
{SSBRI/CRI #5, SSBRI/CRI #6} of 3^{rd} resource group,
{SSBRI/CRI #7, SSBRI/CRI #8} of 4^{th} resource group,
{L1-RSRP/L1-SINR #1, L1-RSRP/L1-SINR #2} of 1^{st} resource group,
{L1-RSRP/L1-SINR #3, L1-RSRP/L1-SINR #4} of 2^{nd} resource group,
{L1-RSRP/L1-SINR #5, L1-RSRP/L1-SINR #6} of 3^{rd} resource group,
{L1-RSRP/L1-SINR #7, L1-RSRP/L1-SINR #8} of 4^{th} resource group,
{I1} of 1^{st} resource group,
{I2} of 2^{nd} resource group,
{I3} of 3^{rd} resource group,
{I4} of 4^{th} resource group}.

It can be learned that in the beam report 6, a piece of fourth indication information corresponding to each group is I1, I2, I3, and I4.

In an implementation, the N pieces of beam information of uplink signals that the terminal is capable of simultaneously sending may be determined based on content indicated by the fourth indication information. For example, if the fourth indication information is 1 bit, when the fourth indication information is 1, it indicates that uplink signals are capable of being simultaneously sent and downlink signals are capable of being simultaneously received based on beam information corresponding to a reference signal resource indicator included in a group corresponding to the fourth indication information. When the fourth indication information is 0, it indicates that only downlink signals are capable of being simultaneously received based on beam information corresponding to a reference signal resource indicator included in a group corresponding to the fourth indication information.

In another implementation, the N pieces of beam information of uplink signals that the terminal is capable of simultaneously sending may be further determined based on an arrangement order or a position of the group in the beam report, which may be agreed upon through a protocol or configured by a network side. For example, for the beam reports 4 to 6, beam information corresponding to reference signal resource indicators included in the first two groups may be determined as beam information of uplink signals that are capable of being simultaneously sent.

A format of the beam report in this embodiment of this application may be considered as a group-based beam report. In an implementation, before step S210, the method further includes:

The terminal receives fifth indication information from the network side device, where the fifth indication information is used to indicate that the beam report to be reported by the terminal includes a group-based beam report.

In an implementation, when determining the N pieces of beam information of uplink signals that the terminal is capable of simultaneously sending, a reference signal indicated by the reference signal resource indicator may be configured as a source reference signal of the beam information.

It can be learned from the technical solution of the foregoing embodiment that, in this embodiment of this application, the beam report includes at least one of the following: the group including at least one reference signal resource indicator; the beam link quality information respectively corresponding to the reference signal resource indicator included in the group; the first index respectively corresponding to the reference signal resource indicator included in the group, where the first index is used to indicate the first information of the terminal; or the fourth indication information corresponding to the group. Therefore, the network side device is capable of quickly determining, based on the beam report, the N pieces of beam information of uplink signals that the terminal is capable of simultaneously sending, and indicating the N pieces of beam information of uplink signals that the terminal is capable of simultaneously sending, thereby improving resource utilization efficiency.

Based on the foregoing embodiment, the beam report may use a beam report of a mixed type including any combination of one or more of the above non-group-based beam report and group-based beam report.

For example, a beam report 7 is shown as follows:
{SSBRI/CRI #1},
{SSBRI/CRI #2},
{SSBRI/CRI #3, SSBRI/CRI #4} of 1^{st} resource group,
{SSBRI/CRI #5, SSBRI/CRI #6} of 2^{nd} resource group,
{L1-RSRP/L1-SINR #1},
{L1-RSRP/L1-SINR #2},
{L1-RSRP/L1-SINR #3, L1-RSRP/L1-SINR #4} of 1^{st} resource group,
{L1-RSRP/L1-SINR #5, L1-RSRP/L1-SINR #6} of 2^{nd} resource group,
Indication #1,
Indication #2,
Indication #3,
Indication #4}.

The beam report further includes indication information corresponding to each reference signal resource indicator and each group, which is equivalent to the second indication information corresponding to each reference signal resource indicator and the fourth indication information corresponding to each group.

N pieces of beam information of uplink signals that the terminal is capable of simultaneously sending may be determined based on each piece of indication information. For example, based on an indicator of the indication information, it is determined whether the reference signal resource indicator corresponding to the indication information or the reference signal resource indicator in the group can be used to determine the N pieces of beam information of uplink signals that are capable of being simultaneously sent. The beam report may only have corresponding indication information for a group. In this case, the indication information is used to indicate whether a group corresponding to the indication information can be used to determine the N pieces of beam information of uplink signals that are capable of being simultaneously sent. Alternatively, the N pieces of beam information of uplink signals that the terminal is capable of simultaneously sending may be determined based on an arrangement order or a position of each reference signal resource indicator and each group in the beam report. For example, Indication #1 and Indication #2 indicate that SSBRI/CRI #1 and SSBRI/CRI #2 cannot be used to determine the N pieces of beam information of uplink signals that are simultaneously sent, but can only be used to determine a single piece of beam information. In this case, Indication #1 and Indication #2 may alternatively be defaulted. For another example, Indication #3 indicates that two SSBRI/CRIs in the 1^{st} resource group can be used to determine two pieces of beam information of uplink signals that are simultaneously sent, and Indication #4 indicates that two SSBRI/CRIs in the 2^{nd} resource group cannot be used to determine two pieces of beam information of uplink signals that are simultaneously sent.

In an implementation, the non-group-based and group-based beam report of the mixed type, before step S210, may be configured by receiving sixth indication information of the network side device, where the sixth indication information may be new indication information, or may include the third indication information and the fifth indication information.

It can be learned from the technical solution of the foregoing embodiment that, in this embodiment of this application, the beam report includes any combination of one or more of the non-group-based beam report and the group-based beam report. Therefore, the network side device is capable of quickly determining, based on the beam report, the N pieces of beam information of uplink signals that the terminal is capable of simultaneously sending, and indicating the N pieces of beam information of uplink signals that the terminal is capable of simultaneously sending, thereby improving resource utilization efficiency.

The information transmission method provided in this embodiment of this application may be performed by an information transmission apparatus. In this embodiment of this application, that the information transmission apparatus performs the information transmission method is used as an example to describe the information transmission apparatus provided in this embodiment of this application.

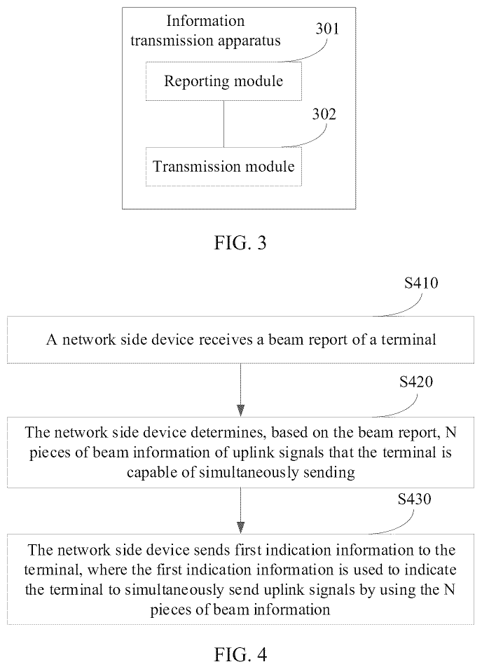

As shown in FIG. 3, the information transmission apparatus includes a reporting module 301 and a transmission module 302.

The reporting module 301 is configured to report a beam report to a network side device based on a beam measurement result, where the beam report is used to determine N pieces of beam information of uplink signals that are capable of being simultaneously sent. The transmission module 302 is configured to receive first indication information from the network side device, where the first indication information is used to indicate to simultaneously send uplink signals by using the N pieces of beam information. N is a positive integer greater than or equal to 2.

Optionally, each of the N pieces of beam information corresponds to any one of the following:
panel identification information of the terminal;
capability value information of the terminal; and
capability value set information of the terminal.

According to the technical solution in the foregoing embodiment, in this embodiment of this application, the beam report is reported to the network side device based on the beam measurement result, and the network side device determines, based on the beam report, the N pieces of beam information of uplink signals that are capable of being simultaneously sent, and indicates the apparatus to simultaneously send uplink signals by using the N pieces of beam information. Therefore, beam information of uplink signals that are capable of being simultaneously sent is quickly determined, and resource utilization efficiency is improved.

Based on the foregoing embodiment, the beam report includes at least one of the following:
a reference signal resource indicator;
a first index corresponding to the reference signal resource indicator, where the first index is used to indicate first information of the terminal;
beam link quality information corresponding to the reference signal resource indicator; or
second indication information corresponding to the reference signal resource indicator, where the second indication information is used to indicate whether the reference signal resource indicator corresponding to a plurality of pieces of beam link quality information may be used to determine the N pieces of beam information of uplink signals that the terminal is capable of simultaneously sending.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

Optionally, before the beam report is reported to the network side device, the reporting module is further configured to receive third indication information from the network side device, where the third indication information is used to indicate that the beam report to be reported includes a non-group-based beam report.

Optionally, the reference signal resource indicator includes at least one of the following:
an SSBRI; or
a CRI.

Optionally, the beam link quality information includes at least one of the following:
an L1-RSRP; or
an L1-SINR.

Optionally, a reference signal indicated by the reference signal resource indicator is used as a source reference signal of the beam information.

It can be learned from the technical solution of the foregoing embodiment that, in this embodiment of this application, the beam report includes at least one of the following: the reference signal resource indicator; the first index corresponding to the reference signal resource indicator, where the first index is used to indicate the first information of the terminal; the beam link quality information corresponding to the reference signal resource indicator; or the second indication information corresponding to the reference signal resource indicator. Therefore, the network side device is capable of quickly determining, based on the beam report, the N pieces of beam information of uplink signals that are capable of being simultaneously sent, and indicating the N pieces of beam information of uplink signals that are capable of being simultaneously sent, thereby improving resource utilization efficiency.

Based on the foregoing embodiment, the beam report further includes at least one of the following:
a group including at least one reference signal resource indicator;
beam link quality information respectively corresponding to a reference signal resource indicator included in the group;
a first index respectively corresponding to a reference signal resource indicator included in the group, where the first index is used to indicate first information of the terminal; or
fourth indication information corresponding to the group, where the fourth indication information is used to indicate at least one of the following:
determining whether N pieces of beam information corresponding to a reference signal resource indicator included in the group are the N pieces of beam information of uplink signals that the terminal is capable of simultaneously sending;
determining whether N pieces of beam information corresponding to the reference signal resource indicator included in the group are N pieces of beam information of downlink signals that the terminal is capable of simultaneously receiving;
a quantity of spatial filters used by the terminal when measuring a first reference signal included in the group; or
a quantity of panels used by the terminal when measuring the first reference signal included in the group.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
a reference signal resource indicator included in the group;
reference signal resource indicators that are included in the group and that correspond to different first indexes;
a reference signal resource indicator that is in the group and that corresponds to a plurality of pieces of beam link quality information;
the fourth indication information; or
an arrangement order or a position of the group in the beam report.

Optionally, before the beam report is reported to the network side device, the reporting module is further configured to receive fifth indication information from the network side device, where the fifth indication information is used to indicate that the beam report to be reported includes a group-based beam report.

Optionally, a reference signal indicated by the reference signal resource indicator is used as a source reference signal of the beam information.

It can be learned from the technical solution of the foregoing embodiment that, in this embodiment of this application, the beam report includes at least one of the following: the group including at least one reference signal resource indicator; the beam link quality information respectively corresponding to the reference signal resource indicator included in the group; the first index respectively corresponding to the reference signal resource indicator included in the group, where the first index is used to indicate the first information; or the fourth indication information corresponding to the group. Therefore, the network side device is capable of quickly determining, based on the beam report, the N pieces of beam information of uplink signals that are capable of being simultaneously sent, and indicating the N pieces of beam information of uplink signals that are capable of being simultaneously sent, thereby improving resource utilization efficiency.

The information transmission apparatus in this embodiment of this application may be an electronic device, for example, an electronic device having an operating system, or may be a component, such as an integrated circuit, or a chip in the electronic device. The electronic device may be a terminal, or another device other than the terminal. For example, the terminal may include but is not limited to the foregoing listed types of the terminal 11. The another device may be a server, a network attached storage (NAS), or the like. This is not specifically limited in the embodiments of this application.

The information transmission apparatus provided in this embodiment of this application can implement the processes implemented in the method embodiment of FIG. 2, and achieve a same technical effect. To avoid repetition, details are not described herein again.

As shown in FIG. 4, an embodiment of this application further provides another information transmission method. The method may be performed by a network side device. In other words, the method may be performed by software or hardware installed in the network side device. The information transmission method includes the following steps.

S410: The network side device receives a beam report from a terminal.

S420: The network side device determines, based on the beam report, N pieces of beam information of uplink signals that the terminal is capable of simultaneously sending.

S430: The network side device sends first indication information to the terminal, where the first indication information is used to indicate the terminal to simultaneously send uplink signals by using the N pieces of beam information.

N is a positive integer greater than or equal to 2.

Optionally, each of the N pieces of beam information corresponds to any one of the following:
panel identification information of the terminal;
capability value information of the terminal; and
capability value set information of the terminal.

According to the technical solution in the foregoing embodiment, in this embodiment of this application, the beam report of the terminal is received, the N pieces of beam information of uplink signals that the terminal is capable of simultaneously sending are determined based on the beam report, and the first indication information is sent to the terminal, where the first indication information is used to indicate the terminal to simultaneously send uplink signals by using the N pieces of beam information. Therefore, beam information of uplink signals that are capable of being simultaneously sent is quickly determined, and resource utilization efficiency is improved.

Based on the foregoing embodiment, the beam report includes at least one of the following:
a reference signal resource indicator;
a first index corresponding to the reference signal resource indicator, where the first index is used to indicate first information of the terminal;
beam link quality information corresponding to the reference signal resource indicator; or
second indication information corresponding to the reference signal resource indicator, where the second indication information is used to indicate whether the reference signal resource indicator corresponding to a plurality of pieces of beam link quality information may be used to determine the N pieces of beam information of uplink signals that the terminal is capable of simultaneously sending.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

Optionally, before step S410, the method further includes:

The network side device sends third indication information to the terminal, where the third indication information is used to indicate that the beam report reported by the terminal includes a non-group-based beam report.

Optionally, the reference signal resource indicator includes at least one of the following:
an SSBRI; or
a CRI.

Optionally, the beam link quality information includes at least one of the following:
an L1-RSRP; or
an L1-SINR.

Optionally, a reference signal indicated by the reference signal resource indicator is used as a source reference signal of the beam information.

It can be learned from the technical solution of the foregoing embodiment that, in this embodiment of this application, the beam report includes at least one of the following: the reference signal resource indicator; the first index corresponding to the reference signal resource indicator, where the first index is used to indicate the first information of the terminal; the beam link quality information corresponding to the reference signal resource indicator; or the second indication information corresponding to the reference signal resource indicator. Therefore, the network side device is capable of quickly determining, based on the beam report, the N pieces of beam information of uplink signals that are capable of being simultaneously sent, and indicating the N pieces of beam information of uplink signals that are capable of being simultaneously sent, thereby improving resource utilization efficiency.

Based on the foregoing embodiment, the beam report further includes at least one of the following:
a group including at least one reference signal resource indicator;
beam link quality information respectively corresponding to a reference signal resource indicator included in the group;
a first index respectively corresponding to a reference signal resource indicator included in the group, where the first index is used to indicate first information of the terminal; or
fourth indication information corresponding to the group, where the fourth indication information is used to indicate at least one of the following:
determining whether N pieces of beam information corresponding to a reference signal resource indicator included in the group are the N pieces of beam information of uplink signals that the terminal is capable of simultaneously sending;
determining whether N pieces of beam information corresponding to the reference signal resource indicator included in the group are N pieces of beam information of downlink signals that the terminal is capable of simultaneously receiving;
a quantity of spatial filters used by the terminal when measuring a first reference signal included in the group; or
a quantity of panels used by the terminal when measuring the first reference signal included in the group.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
a reference signal resource indicator included in the group;
reference signal resource indicators that are included in the group and that correspond to different first indexes;
a reference signal resource indicator that is in the group and that corresponds to a plurality of pieces of beam link quality information;
the fourth indication information; or
an arrangement order or a position of the group in the beam report.

Optionally, before step S410, the method further includes:

The network side device sends fifth indication information to the terminal, where the fifth indication information is used to indicate that the beam report reported by the terminal includes a group-based beam report.

Optionally, a reference signal indicated by the reference signal resource indicator is used as a source reference signal of the beam information.

It can be learned from the technical solution of the foregoing embodiment that, in this embodiment of this application, the beam report includes at least one of the following: the group including at least one reference signal resource indicator; the beam link quality information respectively corresponding to the reference signal resource indicator included in the group; the first index respectively corresponding to the reference signal resource indicator included in the group, where the first index is used to indicate the first information; or the fourth indication information corresponding to the group. Therefore, the network side device is capable of quickly determining, based on the beam report, the N pieces of beam information of uplink signals that are capable of being simultaneously sent, and indicating the N pieces of beam information of uplink signals that are capable of being simultaneously sent, thereby improving resource utilization efficiency.

The information transmission method provided in this embodiment of this application may be performed by an information transmission apparatus. In this embodiment of this application, that the information transmission apparatus performs the information transmission method is used as an example to describe the information transmission apparatus provided in this embodiment of this application.

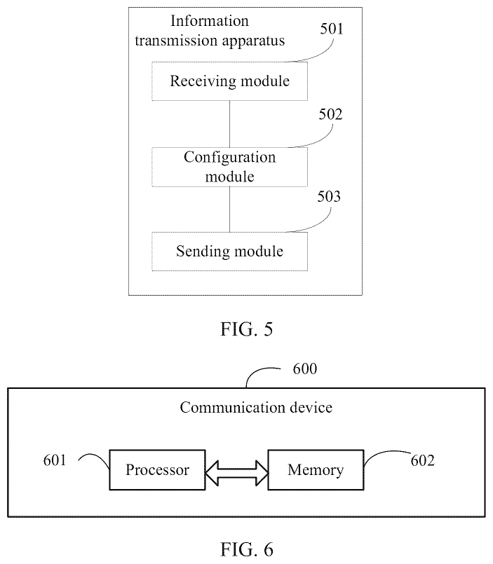

As shown in FIG. 5, the information transmission apparatus includes a receiving module 501, a configuration module 502, and a sending module 503.

The receiving module 501 is configured to receive a beam report from a terminal. The configuration module 502 is configured to determine, based on the beam report, N pieces of beam information of uplink signals that the terminal is capable of simultaneously sending. The sending module 503 is configured to send first indication information to the terminal, where the first indication information is used to indicate the terminal to simultaneously send uplink signals by using the N pieces of beam information. N is a positive integer greater than or equal to 2.

Optionally, each of the N pieces of beam information corresponds to any one of the following:
panel identification information of the terminal;
capability value information of the terminal; and
capability value set information of the terminal.

According to the technical solution in the foregoing embodiment, in this embodiment of this application, the beam report of the terminal is received, the N pieces of beam information of uplink signals that the terminal is capable of simultaneously sending are determined based on the beam report, and the first indication information is sent to the terminal, where the first indication information is used to indicate the terminal to simultaneously send uplink signals by using the N pieces of beam information. Therefore, beam information of uplink signals that are of uplink signals that are capable of being simultaneously sent is quickly determined, and resource utilization efficiency is improved.

Based on the foregoing embodiment, the beam report includes at least one of the following:
a reference signal resource indicator;
a first index corresponding to the reference signal resource indicator, where the first index is used to indicate first information of the terminal;
beam link quality information corresponding to the reference signal resource indicator; or
second indication information corresponding to the reference signal resource indicator, where the second indication information is used to indicate whether the reference signal resource indicator corresponding to a plurality of pieces of beam link quality information may be used to determine the N pieces of beam information of uplink signals that the terminal is capable of simultaneously sending.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

Optionally, before the beam report is reported to the network side device, the sending module is further configured to send third indication information to the terminal, where the third indication information is used to indicate that the beam report reported by the terminal includes a non-group-based beam report.

Optionally, the reference signal resource indicator includes at least one of the following:
an SSBRI; or
a CRI.

Optionally, the beam link quality information includes at least one of the following:
an L1-RSRP; or
an L1-SINR.

Optionally, a reference signal indicated by the reference signal resource indicator is used as a source reference signal of the beam information.

It can be learned from the technical solution of the foregoing embodiment that, in this embodiment of this application, the beam report includes at least one of the following: the reference signal resource indicator; the first index corresponding to the reference signal resource indicator, where the first index is used to indicate the first information of the terminal; the beam link quality information corresponding to the reference signal resource indicator; or the second indication information corresponding to the reference signal resource indicator. Therefore, the N pieces of beam information of uplink signals that are capable of being simultaneously sent can be quickly determined based on the beam report, and the N pieces of beam information of uplink signals that are capable of being simultaneously sent are indicated, thereby improving resource utilization efficiency.

Based on the foregoing embodiment, the beam report further includes at least one of the following:
a group including at least one reference signal resource indicator;
beam link quality information respectively corresponding to a reference signal resource indicator included in the group;
a first index respectively corresponding to a reference signal resource indicator included in the group, where the first index is used to indicate first information of the terminal; or
fourth indication information corresponding to the group, where the fourth indication information is used to indicate at least one of the following:
determining whether N pieces of beam information corresponding to a reference signal resource indicator included in the group are the N pieces of beam information of uplink signals that the terminal is capable of simultaneously sending;
determining whether N pieces of beam information corresponding to the reference signal resource indicator included in the group are N pieces of beam information of downlink signals the terminal is capable of simultaneously receiving;
a quantity of spatial filters used by the terminal when measuring a first reference signal included in the group; or
a quantity of panels used by the terminal when measuring the first reference signal included in the group.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
a reference signal resource indicator included in the group;
reference signal resource indicators that are included in the group and that correspond to different first indexes;
a reference signal resource indicator that is in the group and that corresponds to a plurality of pieces of beam link quality information;
the fourth indication information; or
an arrangement order or a position of the group in the beam report.

Optionally, before the beam report is reported to the network side device, the sending module is further configured to send fifth indication information to the terminal, where the fifth indication information is used to indicate that the beam report reported by the terminal includes a group-based beam report.

Optionally, a reference signal indicated by the reference signal resource indicator is used as a source reference signal of the beam information.

It can be learned from the technical solution of the foregoing embodiment that, in this embodiment of this application, the beam report includes at least one of the following: the group including at least one reference signal resource indicator; the beam link quality information respectively corresponding to the reference signal resource indicator included in the group; the first index respectively corresponding to the reference signal resource indicator included in the group, where the first index is used to indicate the first information; or the fourth indication information corresponding to the group. Therefore, the N pieces of beam information of uplink signals that are capable of being simultaneously sent can be quickly determined based on the beam report, and the N pieces of beam information of uplink signals that are capable of being simultaneously sent are indicated, thereby improving resource utilization efficiency.

The information transmission apparatus in this embodiment of this application may be an electronic device, for example, an electronic device having an operating system, or may be a component, such as an integrated circuit, or a chip in the electronic device. The electronic device may be a terminal, or another device other than the terminal. For example, the terminal may include but is not limited to the foregoing listed types of the terminal 11. The another device may be a server, a network attached storage (NAS), or the like. This is not specifically limited in the embodiments of this application.

The information transmission apparatus provided in this embodiment of this application can implement the processes implemented in the method embodiment of FIG. 4, and achieve a same technical effect. To avoid repetition, details are not described herein again.

Optionally, as shown in FIG. 6, an embodiment of this application further provides a communication device 600, including a processor 601 and a memory 602. The memory 602 stores a program or an instruction executable on the processor 601. For example, when the communication device 600 is a terminal, the program or the instruction is executed by the processor 601 to implement the steps of the foregoing information transmission method embodiment, and achieve a same technical effect. When the communication device 600 is a network side device, the program or the instruction is executed by the processor 601 to implement the steps of the foregoing information transmission method embodiment, and achieve a same technical effect. To avoid repetition, details are not described herein again.

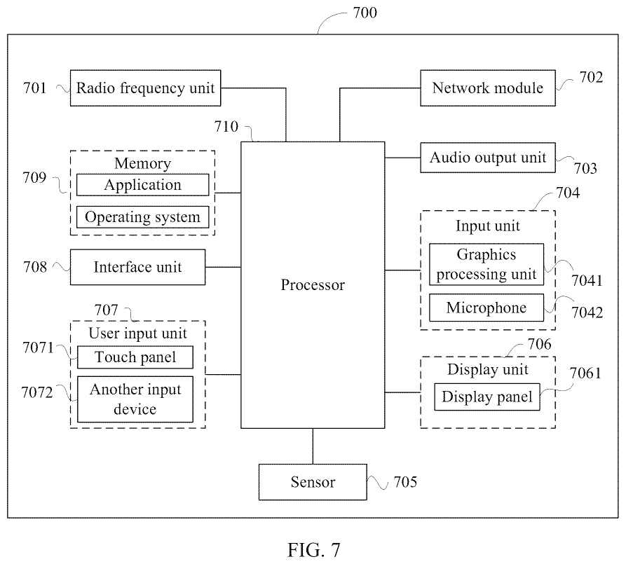

An embodiment of this application further provides a terminal, including a processor and a communication interface. The processor is configured to obtain a beam measurement result, and the communication interface is configured to: report a beam report to a network side device based on the beam measurement result; and receive first indication information from the network side device, where the first indication information is used to indicate to simultaneously send uplink signals by using the N pieces of beam information. The terminal embodiment corresponds to the terminal side method embodiment, each implementation process and implementation of the method embodiment can be applied to the terminal embodiment, and a same technical effect can be achieved. For example, FIG. 7 is a diagram of a hardware structure of a terminal that implements an embodiment of this application.

A terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

It may be understood by a person skilled in the art that the terminal 700 may further include a power supply (such as a battery) that supplies power to each component. The power supply may be logically connected to the processor 710 by using a power management system, to implement functions such as charging, discharging, and power consumption management by using the power management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of liquid crystal display, organic light-emitting diode, or the like. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory, or the memory 709 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The processor 710 is configured to obtain a beam measurement result.

The radio frequency unit 701 is configured to: report a beam report to the network side device based on the beam measurement result, where the beam report is used to determine N pieces of beam information of uplink signals that are capable of being simultaneously sent; and receive first indication information from the network side device, where the first indication information is used to indicate to simultaneously send uplink signals by using the N pieces of beam information.

N is a positive integer greater than or equal to 2.

Optionally, each of the N pieces of beam information corresponds to any one of the following:
panel identification information of the terminal;
capability value information of the terminal; and
capability value set information of the terminal.

According to this embodiment of this application, beam information of uplink signals that are capable of being simultaneously sent can be quickly determined, thereby improving resource utilization efficiency.

Based on the foregoing embodiment, the beam report includes at least one of the following:
a reference signal resource indicator;
a first index corresponding to the reference signal resource indicator, where the first index is used to indicate first information of the terminal;
beam link quality information corresponding to the reference signal resource indicator; or
second indication information corresponding to the reference signal resource indicator, where the second indication information is used to indicate whether the reference signal resource indicator corresponding to a plurality of pieces of beam link quality information may be used to determine the N pieces of beam information of uplink signals that the terminal is capable of simultaneously sending.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

Optionally, before the beam report is reported to the network side device, the radio frequency unit 701 is further configured to receive third indication information from the network side device, where the third indication information is used to indicate that the beam report to be reported includes a non-group-based beam report.

Optionally, the reference signal resource indicator includes at least one of the following:
an SSBRI; or
a CRI.

Optionally, the beam link quality information includes at least one of the following:
an L1-RSRP; or
an L1-SINR.

Optionally, a reference signal indicated by the reference signal resource indicator is used as a source reference signal of the beam information.

According to this embodiment of this application, the N pieces of beam information of uplink signals that are capable of being simultaneously sent can be quickly determined based on the beam report, thereby improving resource utilization efficiency.

Based on the foregoing embodiment, the beam report further includes at least one of the following:
a group including at least one reference signal resource indicator;
beam link quality information respectively corresponding to a reference signal resource indicator included in the group;
a first index respectively corresponding to a reference signal resource indicator included in the group, where the first index is used to indicate first information of the terminal; or
fourth indication information corresponding to the group, where the fourth indication information is used to indicate at least one of the following:
determining whether N pieces of beam information corresponding to a reference signal resource indicator included in the group are the N pieces of beam information of uplink signals that the terminal is capable of simultaneously sending;
determining whether N pieces of beam information corresponding to the reference signal resource indicator included in the group are N pieces of beam information of downlink signals that the terminal is capable of simultaneously receiving;
a quantity of spatial filters used by the terminal when measuring a first reference signal included in the group; or
a quantity of panels used by the terminal when measuring the first reference signal included in the group.

The first information is any one of the following:
panel identification information of the terminal;
capability value information of the terminal; and
capability value set information of the terminal.

Optionally, the N pieces of beam information of uplink signals that the terminal is capable of simultaneously sending are determined by at least one of the following:
a reference signal resource indicator included in the group;
reference signal resource indicators that are included in the group and that correspond to different first indexes;
a reference signal resource indicator that is in the group and that corresponds to a plurality of pieces of beam link quality information;
the fourth indication information; or
an arrangement order or a position of the group in the beam report.

Optionally, before the beam report is reported to the network side device, the radio frequency unit 701 is further configured to receive fifth indication information from the network side device, where the fifth indication information is used to indicate that the beam report to be reported includes a group-based beam report.

Optionally, a reference signal indicated by the reference signal resource indicator is used as a source reference signal of the beam information.

According to the foregoing embodiment, the N pieces of beam information of uplink signals that are capable of being simultaneously sent can be quickly determined based on the beam report, thereby improving resource utilization efficiency.

An embodiment of this application further provides a network side device, including a processor and a communication interface. The processor is configured to determine, based on a beam report, N pieces of beam information of uplink signals that a terminal is capable of simultaneously sending. The communication interface is configured to: receive the beam report of the terminal; and send first indication information to the terminal, where the first indication information is used to indicate the terminal to simultaneously send uplink signals by using the N pieces of beam information. The network side device embodiment corresponds to the foregoing method embodiment of the network side device. Each implementation process and implementation of the foregoing method embodiment may be applicable to the network side device embodiment, and a same technical effect can be achieved.

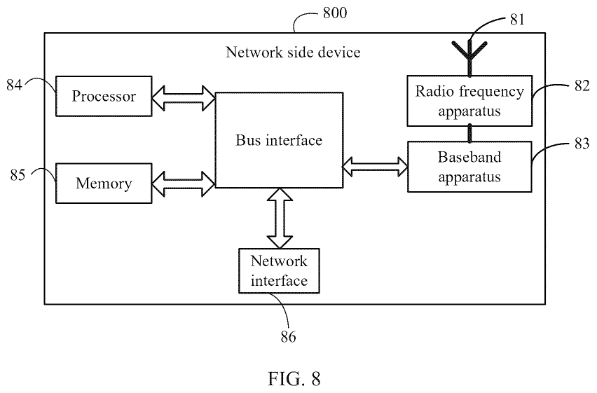

Optionally, an embodiment of this application further provides a network side device. As shown in FIG. 8, a network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes to-be-sent information, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 through a bus interface, to invoke a program in the memory 85 to perform the network device operations shown in the foregoing method embodiment.

The network side device may further include a network interface 86, and the interface is, for example, a common public radio interface (CPRI).

Optionally, the network side device 800 in this embodiment of this application further includes an instruction or a program stored in the memory 85 and executable on the processor 84. The processor 84 invokes the instruction or the program in the memory 85 to perform the method performed by the modules shown in FIG. 5, and achieve a same technical effect. To avoid repetition, details are not described herein again.

An embodiment of this application further provides a non-transitory readable storage medium. The non-transitory readable storage medium stores a program or an instruction, and the program or the instruction is executed by a processor to implement the processes of the foregoing information transmission method embodiment and achieve a same technical effect. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, and the processor is configured to run a program or an instruction to implement the processes of the foregoing information transmission method embodiment, and achieve a same technical effect. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-transitory storage medium, and the computer program/program product is executed by at least one processor to implement the processes of the foregoing information transmission method embodiment, and achieve a same technical effect. To avoid repetition, details are not described herein again.

An embodiment of this application further provides an information transmission system, including a terminal and a network side device. The terminal may be configured to perform the steps of the information transmission method, and the network side device may be configured to perform the steps of the information transmission method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the current technology may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. An information transmission method, comprising:
reporting, by a terminal, a beam report to a network side device based on a beam measurement result, wherein the beam report is used to determine N pieces of beam information of uplink signals that the terminal is capable of simultaneously sending; and
receiving, by the terminal, first indication information from the network side device, wherein the first indication information is used to indicate the terminal to simultaneously send uplink signals by using the N pieces of beam information, wherein
N is a positive integer greater than or equal to 2.

2. The method according to claim 1, wherein the beam report comprises at least one of the following:
a reference signal resource indicator;
a first index corresponding to the reference signal resource indicator, wherein the first index is used to indicate first information of the terminal;
beam link quality information corresponding to the reference signal resource indicator; or
second indication information corresponding to the reference signal resource indicator, wherein the second indication information is used to indicate whether the reference signal resource indicator corresponding to a plurality of pieces of beam link quality information is used to determine the N pieces of beam information of uplink signals that the terminal is capable of simultaneously sending, wherein
the first information is any one of the following:
panel identification information of the terminal;
capability value information of the terminal; and
capability value set information of the terminal.

3. The method according to claim 2, wherein the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

4. The method according to claim 2, wherein before the reporting a beam report to a network side device, the method further comprises:
receiving, by the terminal, third indication information from the network side device, wherein the third indication information is used to indicate that the beam report to be reported by the terminal comprises a non-group-based beam report.

5. The method according to claim 1, wherein the beam report further comprises at least one of the following:
a group comprising at least one reference signal resource indicator;
beam link quality information respectively corresponding to a reference signal resource indicator comprised in the group;
a first index respectively corresponding to a reference signal resource indicator comprised in the group, wherein the first index is used to indicate first information of the terminal; or
fourth indication information corresponding to the group, wherein the fourth indication information is used to indicate at least one of the following:
determining whether N pieces of beam information corresponding to a reference signal resource indicator comprised in the group are the N pieces of beam information of uplink signals that the terminal is capable of simultaneously sending;
determining whether N pieces of beam information corresponding to the reference signal resource indicator comprised in the group are N pieces of beam information of downlink signals that the terminal is capable of simultaneously receiving;
a quantity of spatial filters used by the terminal when measuring a first reference signal comprised in the group; or
a quantity of panels used by the terminal when measuring the first reference signal comprised in the group, wherein
the first information is any one of the following:
panel identification information of the terminal;
capability value information of the terminal; and
capability value set information of the terminal.

6. The method according to claim 5, wherein the N pieces of beam information of uplink signals that the terminal is capable of simultaneously sending are determined by at least one of the following:
a reference signal resource indicator comprised in the group;
reference signal resource indicators that are comprised in the group and that correspond to different first indexes;
a reference signal resource indicator that is in the group and that corresponds to a plurality of pieces of beam link quality information;
the fourth indication information; or
an arrangement order or a position of the group in the beam report.

7. The method according to claim 5, wherein before the reporting a beam report to a network side device, the method further comprises:
receiving, by the terminal, fifth indication information from the network side device, wherein the fifth indication information is used to indicate that the beam report to be reported by the terminal comprises a group-based beam report.

8. The method according to claim 3, wherein a reference signal indicated by the reference signal resource indicator is used as a source reference signal of beam information.

9. The method according to claim 1, wherein each of the N pieces of beam information corresponds to any one of the following:
panel identification information of the terminal;
capability value information of the terminal; and
capability value set information of the terminal.

10. The method according to claim 2, wherein the reference signal resource indicator comprises at least one of the following:
a synchronization signal block resource indicator; or
a channel state information reference signal resource indicator.

11. The method according to claim 2, wherein the beam link quality information comprises at least one of the following:
a layer 1 reference signal received power; or
a layer 1 signal-to-noise and interference ratio.

12. An information transmission method, comprising:
receiving, by a network side device, a beam report from a terminal;
determining, by the network side device based on the beam report, N pieces of beam information of uplink signals that the terminal is capable of simultaneously sending; and
sending, by the network side device, first indication information to the terminal, wherein the first indication information is used to indicate the terminal to simultaneously send uplink signals by using the N pieces of beam information, wherein
N is a positive integer greater than or equal to 2.

13. The method according to claim 12, wherein the beam report comprises at least one of the following:
a reference signal resource indicator;
a first index corresponding to the reference signal resource indicator, wherein the first index is used to indicate first information of the terminal;
beam link quality information corresponding to the reference signal resource indicator; or
second indication information corresponding to the reference signal resource indicator, wherein the second indication information is used to indicate whether the reference signal resource indicator corresponding to a plurality of pieces of beam link quality information is used to determine the N pieces of beam information of uplink signals that the terminal is capable of simultaneously sending, wherein
the first information is any one of the following:
panel identification information of the terminal;
capability value information of the terminal; and
capability value set information of the terminal.

14. The method according to claim 13, wherein the N pieces of beam information of uplink signals that the terminal is capable of simultaneously sending are determined by at least one of the following:
reference signal resource indicators corresponding to N different first indexes;
the reference signal resource indicator corresponding to the plurality of pieces of beam link quality information;
the second indication information corresponding to the reference signal resource indicator; or
an arrangement order or a position of the reference signal resource indicator in the beam report.

15. The method according to claim 13, wherein before the reporting a beam report to a network side device, the method further comprises:
sending, by the network side device, third indication information to the terminal, wherein the third indication information is used to indicate that the beam report reported by the terminal comprises a non-group-based beam report.

16. The method according to claim 12, wherein the beam report further comprises at least one of the following:
a group comprising at least one reference signal resource indicator;
beam link quality information respectively corresponding to a reference signal resource indicator comprised in the group;
a first index respectively corresponding to a reference signal resource indicator comprised in the group, wherein the first index is used to indicate first information of the terminal; or
fourth indication information corresponding to the group, wherein the fourth indication information is used to indicate at least one of the following:
determining whether N pieces of beam information corresponding to a reference signal resource indicator comprised in the group are the N pieces of beam information of uplink signals that the terminal is capable of simultaneously sending;
determining whether N pieces of beam information corresponding to the reference signal resource indicator comprised in the group are N pieces of beam information of downlink signals that the terminal is capable of simultaneously receiving;
a quantity of spatial filters used by the terminal when measuring a first reference signal comprised in the group; and
a quantity of panels used by the terminal when measuring the first reference signal comprised in the group, wherein
the first information is any one of the following:
panel identification information of the terminal;
capability value information of the terminal; or
capability value set information of the terminal.

17. The method according to claim 16, wherein the N pieces of beam information of uplink signals that the terminal is capable of simultaneously sending are determined by at least one of the following:
a reference signal resource indicator comprised in the group;
reference signal resource indicators that are comprised in the group and that correspond to different first indexes;
a reference signal resource indicator that is in the group and that corresponds to a plurality of pieces of beam link quality information;
the fourth indication information; or
an arrangement order or a position of the group in the beam report.

18. The method according to claim 16, wherein before the reporting a beam report to a network side device, the method further comprises:
sending, by the network side device, fifth indication information to the terminal, wherein the fifth indication information is used to indicate that the beam report reported by the terminal comprises a group-based beam report.

19. A terminal, comprising a processor and a memory, wherein the memory stores a program or an instruction executable on the processor, and the program or the instruction, when executed by the processor, causes the terminal to perform:
reporting a beam report to a network side device based on a beam measurement result, wherein the beam report is used to determine N pieces of beam information of uplink signals that the terminal is capable of simultaneously sending; and
receiving first indication information from the network side device, wherein the first indication information is used to indicate the terminal to simultaneously send uplink signals by using the N pieces of beam information, wherein
N is a positive integer greater than or equal to 2.

20. A network side device, comprising a processor and a memory, wherein the memory stores a program or an instruction executable on the processor, and the program or the instruction is executed by the processor to implement the steps of the information transmission method according to claim 12.
